(19) United States
(12) Patent Application Publication
(10) Pub. No.: US 2015/0035722 A1
(43) Pub. Date: Feb. 5, 2015

(54) DOMESTIC APPLIANCE HAVING A PLURALITY OF DISPLAYS AND ACTUATION METHOD FOR SAID DOMESTIC APPLIANCE

(71) Applicant: BSH Bosch und Siemens Hausgeräte GmbH, Munich (DE)

(72) Inventor: Andreas Ainöder, Regensburg (DE)

(21) Appl. No.: 14/377,977

(22) PCT Filed: Jan. 29, 2013
(86) PCT No.: PCT/EP2013/051663

§ 371 Date: Aug. 11, 2014

(30) Foreign Application Priority Data
Feb. 10, 2012 (DE) 10 2012 202 037.3

(51) Int. Cl. G06F 3/14

(52) U.S. Cl. CPC G06F 3/1431
USPC 345/1.2

(57) ABSTRACT

The invention relates to a domestic appliance having a display device for displaying images and having a microprocessor which is designed to provide an image signal which characterizes an image which is to be displayed on the display device, wherein the display device has at least two separate displays and the domestic appliance has an image splitter which differs from the microprocessor and is connected between the microprocessor and the display device and is designed to receive the image signal from the microprocessor, to split the same image signal into at least two image signal elements which each characterize an element of the image which is to be displayed, and to output the at least two image signal elements to the respective displays and, in this way, to display the image in split form on the at least two displays.

The invention relates to a domestic appliance having a display facility, which is configured to display images, and having a microprocessor (for example a graphics processor) which is designed to provide an image signal which characterizes an image to be displayed on the display facility. The invention also relates to a method for operating a display facility of a domestic appliance.

It is already the approach of the prior art to equip domestic appliances, such as an oven, washing machine, refrigerator or dishwasher for example, with a display facility. A very wide range of, for example operation related, information can then be displayed on the display facility, specifically for example a menu with a plurality of selectable menu inputs. In the context of the present application a display on the display facility is generally referred to as an “image”.

Of particular interest in the present instance are domestic appliances having a relatively large display facility. One disadvantage of such domestic appliances is in particular that the display facilities with relatively large dimensions are relatively expensive as well as being less flexible in respect of design or the configuration of the domestic appliance.

The object of the invention is to demonstrate a solution for allowing the display facility of a domestic appliance of the type mentioned in the introduction to be embodied as relatively large, thereby allowing the disadvantages of the prior art to be circumvented.

According to the invention this object is achieved by a domestic appliance and by a method with the features claimed in the respective independent claims. Advantageous embodiments of the invention form the subject matter of the dependent claims, the description and the figures.

An inventive domestic appliance has a display facility which is configured to display images or displays. The domestic appliance also comprises a microprocessor for example a graphics processor which is designed to provide an image signal which characterizes an image to be displayed on the display facility. The display facility has at least two separate displays and the domestic appliance comprises an image splitter which differs from the microprocessor and is connected between the microprocessor and the display facility, said image splitter being designed to receive the image signal from the microprocessor, to split the same image signal into at least two image signal elements, which each characterize a subregion of the image to be displayed, and to output the at least two image signal elements to the respective displays and in this way to display the image in split form on the at least two displays.

In order to eliminate the disadvantages of the prior art the invention therefore takes the route of employing a number of smaller displays instead of a single large display and of configuring the domestic appliance with an image splitter, which can be used to split the image signal from the microprocessor into a number of image signal elements, which each characterize just one subregion of the image to be displayed. The image to be displayed is therefore displayed split between the at least two displays. The overall image is therefore distributed to at least two displays so that one subregion of the image is displayed on one of the displays and the remaining subregion of the image is displayed on the other display. The inventive procedure has the following advantages: the proposed solution is particularly flexible, as the image splitter can be employed with any microprocessor, as long as the microprocessor can provide the image signal, in particular specifically a digital image signal, preferably an RGB image signal. Also the components already present do not have to be adapted; from the point of view of the microprocessor the image splitter behaves in the manner of a single large display. The microprocessors already present can therefore continue to be used. In some instances just the resolution and timing of the drivers can be adjusted. The use of a number of smaller displays is also more economical than employing one large display. The inventive domestic appliance also has design advantages. A further advantage is that with a number of displays the microprocessor used has to have a single display interface, processors with a number of display interfaces being disproportionately more expensive for the same core performance than a microprocessor with just one interface and a downstream image splitter.

A domestic appliance in the present instance refers to an appliance used for household management. The domestic appliance is preferably a large domestic appliance, for example a washing machine, tumble dryer, dishwasher, cooking appliance, extractor hood, refrigeration appliance, combined refrigerator/freezer or air conditioning appliance. In particular the domestic appliance is an appliance for laundry care or an appliance for preparing food or a dishwasher. However it can also be a small domestic appliance, for example a food processor or coffee machine.

It is particularly preferable for the microprocessor to have an RGB (red green blue) output, at which the image signal can be output as an RGB signal. With this embodiment the image splitter can therefore receive an RGB signal and provide at least two RGB image signal elements from said RGB signal, it being possible to output these to the respective individual displays. The RGB signal is a digital signal that can be processed digitally by the image splitter. A digital RGB interface has the advantage that it provides a larger transmission bandwidth than for example the MPU/MCU interface. Also such an RGB signal can be split into a number of image signal elements using the image splitter without much outlay, so that the image splitter alone can be embodied in a relatively compact, economical and simple manner.

In one embodiment provision is made for the logic of the image splitter to be implemented in an FPGA (field programmable gate array). The image splitter can thus be an FPGA module, in which the logic is programmed by a logic circuit. Such an FPGA module in particular has the advantages that implementation times are relatively short and development costs are also much lower than for other ICs. An FPGA is also particularly compact so that valuable space can be saved in the domestic appliance.

In one alternative embodiment provision is made for the image splitter to be embodied as an ASIC (application-specific integrated circuit), in other words an electronic circuit implemented in the manner of an integrated switching circuit, the logic of which can no longer be manipulated.

It proves to be particularly advantageous if the image splitter has an internal memory, specifically in particular a volatile memory, in which at least one subregion of the image can be stored before the image signal elements are generated. It is thus possible to generate the at least two image signal elements without much outlay; the image splitter can first store at least one subregion of the received image—for example a line of the image—in the memory and then split the stored subregion—in particular the stored line of the image—between the at least two displays.

TFT displays are preferably used in the display facility. Already standardized displays can therefore be used, these already being available in a number of forms on the market.

An inventive method serves to operate a display facility of a domestic appliance which has at least two separate displays. A microprocessor is used to provide an image signal which characterizes an image to be displayed on the display facility. The image signal is received by means of an image splitter and split into at least two image signal elements which each characterize a subregion of the image to be displayed. The at least two image signal elements are output to the respective displays so that the image is displayed split between the at least two displays.

The preferred embodiments presented in respect of the inventive domestic appliance and their advantages apply correspondingly to the inventive method.

Further features of the invention will emerge from the claims, the figures and the description of the figures. All the features and feature combinations cited above in the description as well as the features and feature combinations cited below in the description of the figures and/or just shown in the figures can be used not only in the combination specified in each instance but also in other combinations or alone.

The invention is now described in more detail based on a preferred exemplary embodiment, as well as with reference to the accompanying drawings, in which:

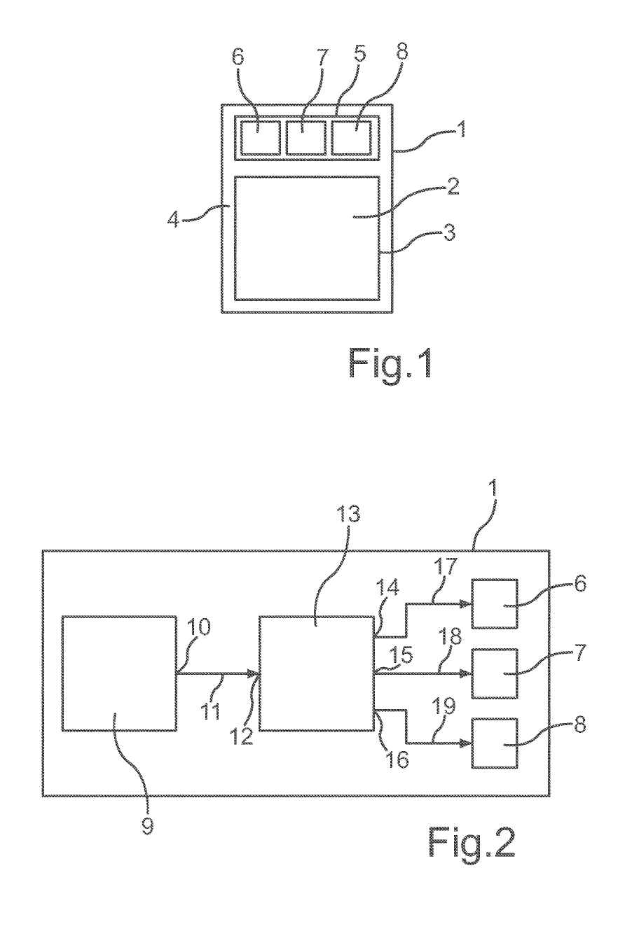

FIG. 1 shows a schematic diagram of a domestic appliance according to one embodiment of the invention;

FIG. 2 shows a block diagram of the domestic appliance according to FIG. 1; and

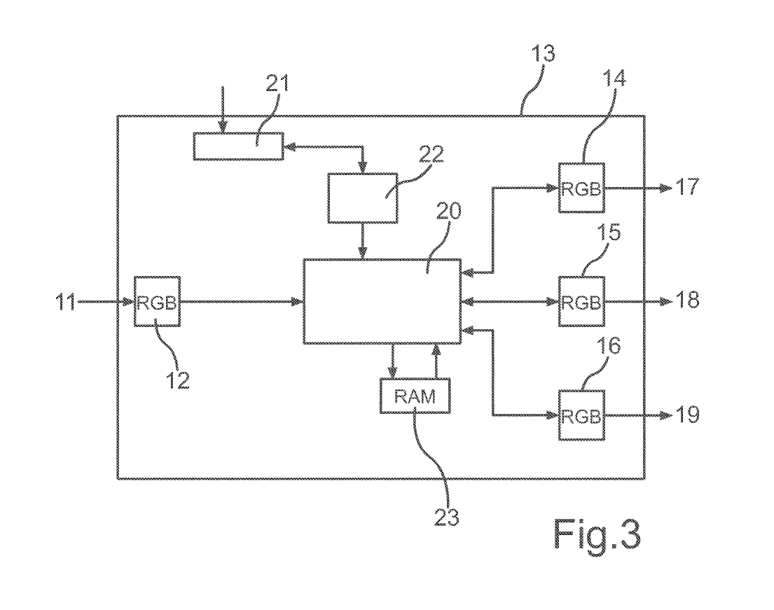

FIG. 3 shows a block diagram of an image splitter configured as an FPGA and configured to split an image signal into at least two image signal elements.

A domestic appliance 1 shown in FIG. 1 is an oven for example. The domestic appliance 1 has a cooking chamber 2, in which food can be prepared. The cooking chamber 2 can be closed by means of a door 3 in the conventional manner. Arranged in the upper region of a front face 4 of the domestic appliance 1 is a display facility 5, which has at least two individual displays, in the exemplary embodiment three displays 6, 7, 8. The display facility 5 therefore comprises a first display 6, a second display 7 and a third display 8. These are separate displays 6, 7, 8 which are arranged next to one another for example along a horizontal line and adjoin one another directly for example so that they form a large homogeneous display. The arrangement and number of the individual displays 6, 7, 8 can however be any that are required in principle. The number of displays 6, 7, 8 can be in a value range from 2 to 5 for example and is preferably 2 or 3.

A schematic diagram of a block diagram of the domestic appliance 1 according to FIG. 1 is shown in FIG. 2. A homogeneous display, in other words a homogeneous image, can be shown as a whole on the displays 6, 7, 8. The term “image” here refers to any possible display that can be displayed on the displays 6, 7, 8. It can be for example operating information which informs the user of the domestic appliance 1 about the current values of operating parameters of the domestic appliance 1. The display on the displays 6, 7, 8 can also be moving animations, a video for example, generated by displaying a sequence of individual images over time. However for the sake of simplicity the mode of operation of the domestic appliance 1 is described below with reference to a single image to be displayed.

The domestic appliance 1 has a microprocessor 9, which is configured as a graphics processor, and an RGB output 10, at which an image signal 11, which is an RGB signal, can be output. The RGB output 10 of the microprocessor 9 is connected electrically to an RGB input 12 of an image splitter 13, which is an RGB image splitter. The image splitter 13 thus receives the digital image signal 11. The image splitter 13 has a plurality of RGB outputs, in the exemplary embodiment specifically three separate RGB outputs 14, 15, 16. The first RGB output 14 is connected to the first display 6, while the second RGB output 15 is connected to the second display 7. The third RGB output 16 is connected to the third display 8.

The image splitter 13 can split the received image signal 11 into three image signal elements which are RGB signals. A first image signal element 17 is output at the first RGB output 14, a second image signal element 18 is output at the second RGB output 15 and a third image signal element 19 is output at the third RGB output 16. The image signal elements 17, 18, 19 each characterize a subregion of the image to be displayed as a whole, as generated by the microprocessor 9. All the subregions here together form the overall image, which is displayed on the displays. This means that the first subregion of the image is displayed on the first display 6, while the second subregion is displayed on the second display 7 and the third subregion of the overall image is displayed on the third display 8, so that the display on all the displays 6, 7, 8 corresponds to the overall image generated by the microprocessor 9.

The displays 6, 7, 8 can be TFT displays for example.

The image splitter 13 is a digital component which can process the digital image signal 11 digitally. It is preferable for the logic of the image splitter 13 to be implemented in an FPGA. A block diagram of such an image splitter 13 is shown by way of example in FIG. 3. The core of the image splitter 13 is a logic block 20 which is used to split the RGB image signal 11 into three different image signal elements 17, 18, 19. The image splitter 13 also has a configuration input 21, by way of which configuration data can be supplied to the image splitter 13, for example from the microprocessor 9. The configuration data can be the following data: the image resolution, the number of displays 6, 7, 8, the coordinates at which the image is to be split into a number of subregions and the like. This configuration data can then be stored in a register 22.

The image splitter 13 also has an internal memory 23, which can be for example a RAM memory. At least one region of the received image can be stored in the memory 23 before said region of the image is distributed to the individual displays 6, 7, 8. This can be such for example that each received line of the image is stored in the memory 23 first before said lines are divided into three line segments which are then output to the respective displays 6, 7, 8. The overall image can therefore be split into a number of image subregions line by line.

### LIST OF REFERENCE CHARACTERS

1 Domestic appliance

2 Cooking chamber

3 Door

4 Front face

5 Display facility

6, 7, 8 Displays

9 Microprocessor

10 RGB output

11 Image signal

12 RGB input

13 Image splitter

14, 15, 16 RGB output

17, 18, 19 Image signal elements

20 Logic block

21 Configuration input

22 Register

23 Memory

1. A domestic appliance having a display facility for displaying images and having a microprocessor which is designed to provide an image signal which characterizes an image to be displayed on the display facility, characterized in that the display facility 5) has at least two separate displays and the domestic appliance comprises an image splitter which differs from the microprocessor and is connected between the microprocessor and the display facility, said image splitter being designed to receive the image signal from the microprocessor, to split the same image signal into at least two image signal elements which each characterize a subregion of the image to be displayed, and to output the at least two image signal elements to the respective displays and in this way to display the image in split form on the at least two displays.

2. The domestic appliance as claimed in claim 1, wherein the microprocessor has an RGB output, at which the image signal can be output as an RGB signal.

3. The domestic appliance as claimed in claim 1, wherein the logic of the image splitter is implemented in an FPGA.

4. The domestic appliance as claimed in claim 1, wherein the image splitter is configured as an ASIC circuit.

5. The domestic appliance as claimed in claim 1, wherein the image splitter has an internal memory, in which at least one subregion of the image can be stored.

6. The domestic appliance as claimed in claim 1, wherein the at least two displays are configured as TFT displays.

7. A method for operating a display facility of a domestic appliance which has at least two separate displays, having the steps:
using a microprocessor to provide an image signal, which characterizes an image to be displayed on the display facility,
receiving the image signal by means of an image splitter and splitting the image signal into at least two image signal elemental, which each characterize a subregion of the image to be displayed, and
outputting the at least two image signal elements to the respective displays and in this way displaying the image in split form on the at least two displays.
